(19) United States
(12) Patent Application Publication
(10) Pub. No.: US 2026/0059370 A1
(43) Pub. Date: Feb. 26, 2026

(54) UE-INITIATED CSI

(71) Applicant: Samsung Electronics Co., Ltd., Suwon-si (KR)

(72) Inventors: Md. Saifur Rahman, Plano, TX (US); Dalin Zhu, Allen, TX (US); Emad Nader Farag, Flanders, NJ (US); Gilwon Lee, Prosper, TX (US); Eko Onggosanusi, Coppel, TX (US)

(21) Appl. No.: 19/288,954

(22) Filed: Aug. 1, 2025

Related U.S. Application Data
(60) Provisional application No. 63/686,590, filed on Aug. 23, 2024.

(51) Int. Cl. H04W 24/10; H04W 72/21

(52) U.S. Cl. CPC H04W 24/10; H04W 72/21

(57) ABSTRACT

Apparatuses and methods for user equipment (UE)-initiated channel state information (CSI). A method performed by a UE includes transmitting, via a first uplink (UL) channel in a first slot, a UE initiated (UEI) request for a CSI report and a CSI-related info indicating information about a payload of the CSI report. The method further includes determining the CSI report and transmitting the CSI report via a second UL channel in a second slot.

### CROSS-REFERENCE TO RELATED AND CLAIM OF PRIORITY

The present application claims priority under 35 U.S.C. § 119(e) to U.S. Provisional Patent Application No. 63/686,590 filed on Aug. 23, 2024, which is hereby incorporated by reference in its entirety.

### TECHNICAL FIELD

The present disclosure relates generally to wireless communication systems and, more specifically, the present disclosure is related to apparatuses and methods for user equipment (UE)-initiated channel state information (CSI).

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UE-initiated CSI.

In one embodiment, a UE is provided. The UE includes a transceiver configured to transmit, via a first uplink (UL) channel in a first slot, a UE initiated (UEI) request for a CSI report and a CSI-related info indicating information about a payload of the CSI report. The UE further includes a processor operably coupled to the transceiver. The processor is configured to determine the CSI report. The transceiver is further configured to transmit the CSI report via a second UL channel in a second slot.

In another embodiment, a base station (BS) is provided. The BS includes a processor and a transceiver operably coupled to the processor. The transceiver configured to receive, via a first UL channel in a first slot, a UEI request for a CSI report and a CSI-related info indicating information about a payload of the CSI report and receive the CSI report via a second UL channel in a second slot.

In yet another embodiment, a method performed by a UE is provided. The method includes transmitting, via a first UL channel in a first slot, a UEI request for a CSI report and a CSI-related info indicating information about a payload of the CSI report. The method further includes determining the CSI report and transmitting the CSI report via a second UL channel in a second slot.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example uplink control information (UCI) omission according to embodiments of the present disclosure;

FIG. 7 illustrates an example two-part CSI according to embodiments of the present disclosure;

FIG. 8 illustrates a flowchart of an example procedure for DL operation according to embodiments of the present disclosure;

FIGS. 9A, 9B, and 9C illustrate signal flows of example procedures for UE transmission according to embodiments of the present disclosure;

FIGS. 10A, 10B, and 10C illustrate signal flows of example procedures for UE transmission according to embodiments of the present disclosure;

FIG. 11 illustrates an example procedure for configuring a two-part UCI according to embodiments of the present disclosure;

FIG. 12 illustrates an example procedure for configuring a two-part UCI according to embodiments of the present disclosure;

FIG. 13 illustrates example timelines for configuring a two-part UCI according to embodiments of the present disclosure;

FIG. 14 illustrates example timelines for configuring a two-part UCI according to embodiments of the present disclosure;

FIG. 15 illustrates example procedures for configuring a two-part UCI according to embodiments of the present disclosure; and

FIG. 16 illustrates an example method performed by a UE in a wireless communication system according to embodiments of the present disclosure.

### DETAILED DESCRIPTION

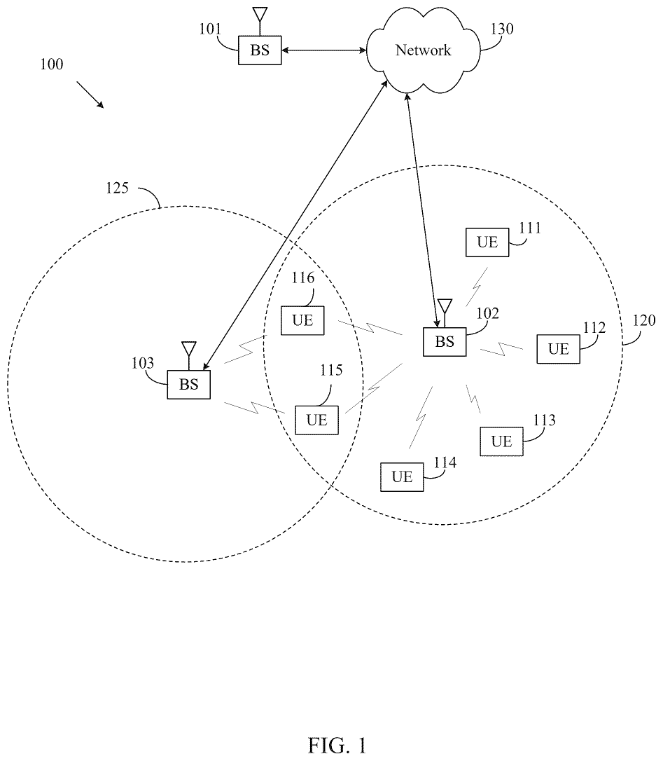

FIGS. 1-16 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v18.0.0, “NR, Physical channels and modulation;” [REF 2] 3GPP TS 38.212 v18.0.0, “NR, Multiplexing and Channel coding;” [REF 3] 3GPP TS 38.213 v18.0.0, “NR, Physical Layer Procedures for Control;” [REF 4] 3GPP TS 38.214 v18.0.0, “NR, Physical Layer Procedures for Data;” [REF 5] 3GPP TS 38.215 v18.0.0, “NR, Physical Layer Measurements;” [REF 6] 3GPP TS 38.321 v18.0.0, “NR, Medium Access Control (MAC) protocol specification;” and [REF 7] 3GPP TS 38.331 v18.0.0, “NR, Radio Resource Control (RRC) Protocol Specification.”

FIGS. 1-15 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing UE-initiated CSI. In certain embodiments, one or more of the BSs 101-103 include circuitry, programing, or a combination thereof to support UE-initiated CSI.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

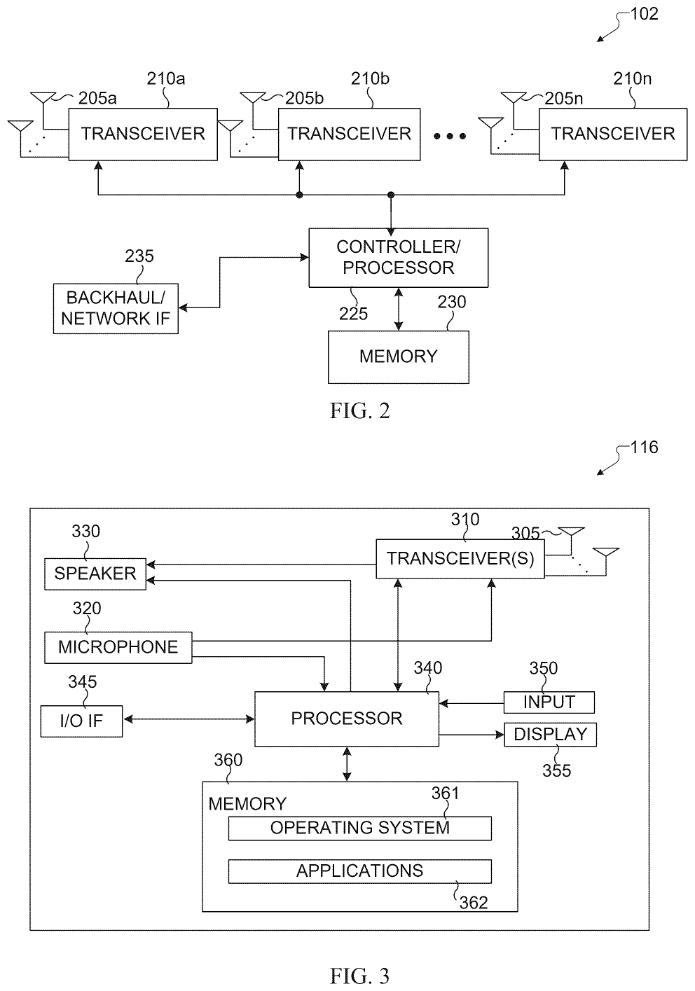

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for UE-initiated CSI. Any of a wide variety of other functions could be supported in the gNB 102 by the controller/processor 225.

The controller/processor 225 is also capable of executing programs and other processes resident in the memory 230, such as processes to support UE-initiated CSI. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for UE-initiated CSI as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

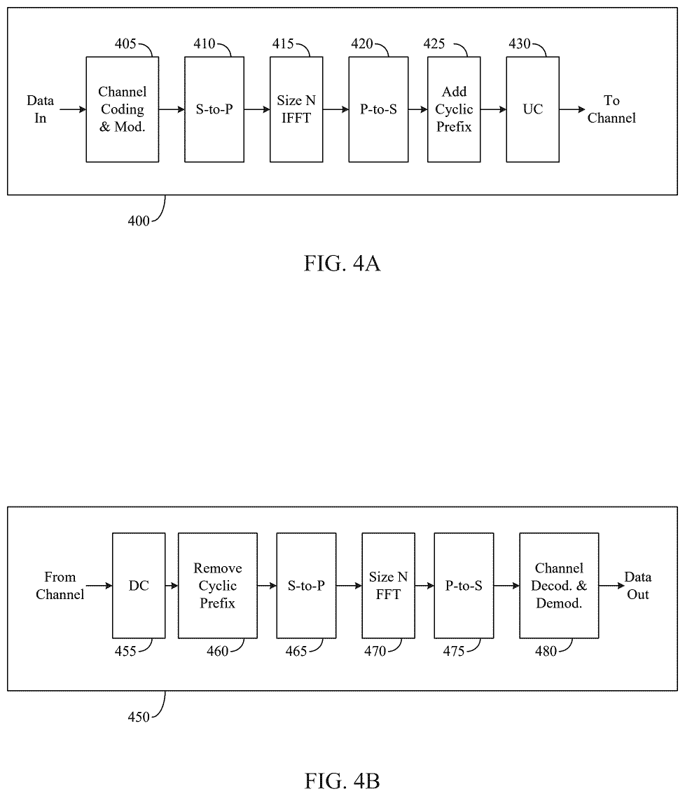

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for UE-initiated CSI as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

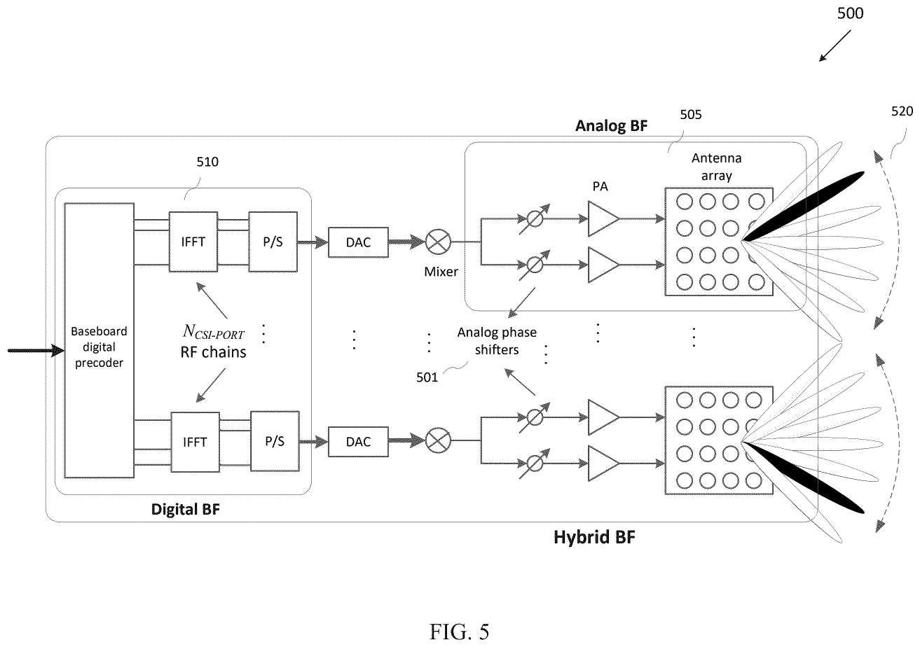

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

The present disclosure relates generally to wireless communication systems and, more specifically, to UCI carrying CSI where CSI is based on a UE-initiated report.

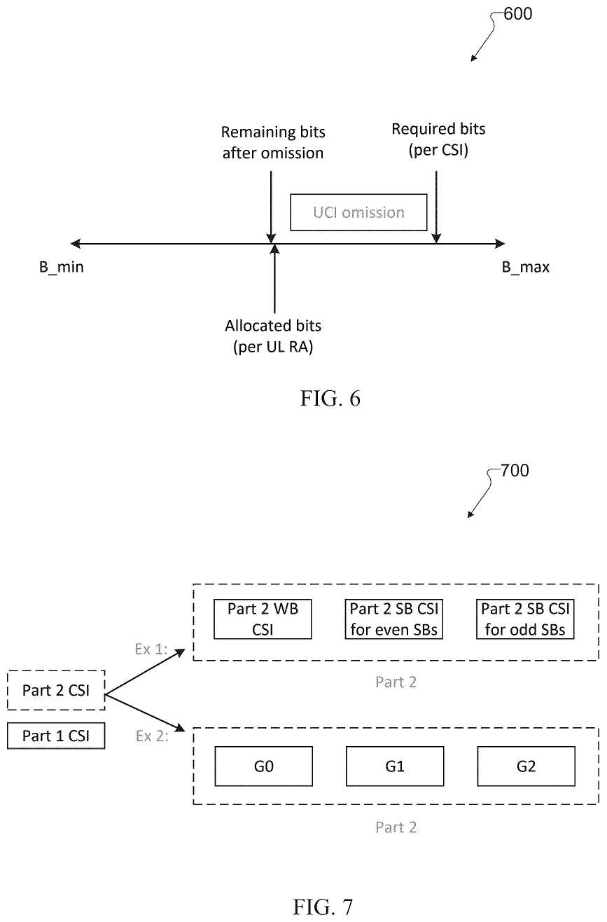

FIG. 6 illustrates an example UCI omission 600 according to embodiments of the present disclosure. For example, UCI omission 600 can be implemented by any of the UEs 111-116 of FIG. 1. This example is for illustration only and other embodiments can be used without departing from the scope of the present disclosure.

In (LTE or 5G NR) specification, the most resource-efficient reporting mechanism for a content (e.g. beam, CSI etc., or in general different report quantities) is aperiodic (in conjunction with aperiodic CSI-RS or sounding reference signal (SRS)). On the other hand, with a well-chosen periodicity, periodic reporting (followed by semi-persistent) results in the lowest latency at the expense of resources. Although aperiodic reporting seems preferred from the overall operational perspective, embodiments of the present disclosure recognize that, in a few relevant scenarios, the NW/gNB lacks knowledge on the DL channel condition—or, in other words, the UE knows the DL channel condition better. In this case, it is clearly beneficial if the UE can initiate its own aperiodic reporting for a content (e.g. beam, CSI etc.). For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB.

FIG. 7 illustrates an example two-part CSI 700 according to embodiments of the present disclosure. For example, two-part CSI 700 can be transmitted by any of the UEs 111-116 of FIG. 1, such as the UE 111. This example is for illustration only and other embodiments can be used without departing from the scope of the present disclosure.

Such UE-initiated reporting for a content can also be enabled for other types of report quantities (different from beam or CSI reports) or UE procedures. For instance, a two-part UCI is used for SB CSI reporting in 5G NR, where the payload of UCI part 1 carrying CSI part 1 is fixed, but the payload of UCI part 2 carrying CSI part 2 is variable. The information about the payload of CSI part 2 is provided via CSI part 1. The NW decodes UCI part 1 first. Subsequently, it decodes UCI part 2 based on the decoded information about the payload of CSI part 2. When UL resource allocation (UL RA) for CSI report(s) is not sufficient (i.e. number of allocated bits via UL RA is less than number of required bits for CSI report(s)), UE omits a portion of the CSI report(s) until remaining CSI bits (after omission) is less or equal to the allocated bits (per UL RA), as illustrated in FIG. 6.

UCI omission procedure: for (high-res) CSI feedback on physical uplink shared channel (PUSCH), a CSI report comprises of two parts. Part 1 has a fixed payload size and is used to identify the number of information bits in Part 2. Part 1 shall be transmitted in its entirety before Part 2. When CSI reporting on PUSCH comprises two parts, the UE (e.g., the UE 116) may omit a portion of the Part 2 CSI. Omission of Part 2 CSI is according to the priority order shown in Table 1, where N_{Rep} is the number of CSI reports configured to be carried on the PUSCH. Priority 0 is the highest priority and priority 2N_{Rep} is the lowest priority and the CSI report n corresponds to the CSI report with the nth smallest Pri_{i,CSI}(y,k,c,s) value among the N_{Rep} CSI reports as defined in Clause 5.2.5 of [4]. The subbands for a given CSI report n indicated by the higher layer parameter csi-ReportingBand are numbered continuously in increasing order with the lowest subband of csi-ReportingBand as subband 0. When omitting Part 2 CSI information for a particular priority level, the UE shall omit the information at that priority level.

Two examples of further partitioning/grouping Part 2 CSI are shown in FIG. 7. In one example, Ex 1 in FIG. 7 is used when the precoding matrix indicator (PMI) codebook does not include FD basis vectors (i.e., there is no FD compression), and Ex 2 in FIG. 7 is used when the PMI codebook includes FD basis vectors, (i.e., there is FD compression e.g. codebookType configured as ‘typeII-r16’, ‘typeII-PortSelection-r16’ or ‘typeII-PortSelection-r17’ or ‘typeII-Doppler-r18’ or ‘typeII-Doppler-PortSelection-r18’).

TABLE 1
Priority reporting levels for Part 2 CSI

Priority 0:
For CSI reports 1 to N_{Rep},
Group 0 CSI for CSI reports, or
Part 2 wideband CSI
Priority 1:
Group 1 CSI for CSI report 1, or
Part 2 subband CSI of even subbands for CSI report 1
Priority 2:
Group 2 CSI for CSI report 1, or
Part 2 subband CSI of odd subbands for CSI report 1
Priority 3:
Group 1 CSI for CSI report 2, or
Part 2 subband CSI of even subbands for CSI report 2
Priority 4:
Group 2 CSI for CSI report 2, or
Part 2 subband CSI of odd subbands for CSI report 2
.
.
.
Priority 2N_{Rep} − 1:
Group 1 CSI for CSI report N_{Rep}, or
Part 2 subband CSI of even subbands for CSI report
N_{Rep}
Priority 2N_{Rep}:
Group 2 CSI for CSI report N_{Rep}, or
Part 2 subband CSI of odd subbands for CSI report N_{Rep}

The CSI/UCI omission may occur for CSI report(s) with variable payloads. When the payload variation (i.e., Bₘₐₓ-Bₘᵢₙ in FIG. 7) is large, UL RA can be an issue. When UL RA is according to max payload (Bₘₐₓ value), it can correspond to large UL resource, which may not be utilized (when required CSI payload is small). On the contrary, when UL RA is less than max payload (e.g. close to Bₘᵢₙ value), it may cause UCI omission. Either way, the system will suffer, and the issue gets worse as the range of payload variation increases, which is the case with Type II CSI reporting. One solution to address this issue can be based on UE-initiated (UEI) or UE-assisted (UEA) approach wherein the UE initiates or assists the NW in UL RA by providing a CSI-related information that can help reduce large payload variations in CSI report(s). This disclosure provides example embodiments on such UEI/UEA approaches.

The present disclosure relates to UE-initiated or UE-assisted UCI design in a communication system. The aspects includes the following:
UE-initiated or UE-assisted UL RA for UCI (carrying CSI)
Details on two-part UCI/CSI (contents)
UCI omission procedure

In the following, for brevity, both frequency division duplexing (FDD) and time division duplexing (TDD) are regarded as the duplex method for both DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure covers several components which can be used in conjunction or in combination with one another, or can operate as standalone schemes.

In the present disclosure, the term “activation” describes an operation wherein a UE receives and decodes a signal from the network (or gNB) that signifies a starting point in time. The starting point can be a present or a future slot/subframe or symbol—the exact location either implicitly or explicitly indicated, or otherwise fixed or higher-layer configured. Upon successfully decoding the signal, the UE responds accordingly. The term “deactivation” describes an operation wherein a UE receives and decodes a signal from the network (or gNB) that signifies a stopping point in time. The stopping point can be a present or a future slot/subframe or symbol—the exact location either implicitly or explicitly indicated, or otherwise fixed or higher-layer configured. Upon successfully decoding the signal, the UE responds accordingly.

Terminology such as transmission configuration indication (TCI), TCI states, SpatialRelationInfo, target RS, reference RS, and other terms is used for illustrative purposes and therefore not normative. Other terms that refer to the same functions can also be used.

A “source RS” corresponds to a set of characteristics of DL or UL TX beam, such as direction, precoding/beamforming, number of ports, etc. For instance, as the UE receives a source RS index/ID in a DL assigned represented by a TCI state, the UE applies the known characteristics of the source RS to the assigned DL transmission (or/and UL transmission). The source RS can be received and measured by the UE (in this case, the source RS is a downlink measurement signal such as nonzero power (NZP) CSI-RS and/or synchronization signal block (SSB)) with the result of the measurement used for calculating a beam report (at least one L1-reference signal received power (RSRP)/L1-signal-to-interference-plus-noise ratio (SINR) accompanied by at least one channel quality indicator report interval (CRI) or SSB resource indicator (SSBRI)). As the NW/gNB (e.g., the BS 102) receives the beam report, the NW can be better equipped with information to assign a particular DL (or/and UL) TX beam to the UE. Optionally, the source RS can be transmitted by the UE (in this case, the source RS is a uplink measurement signal such as SRS). As the NW/gNB receives the source RS, the NW/gNB can measure and calculate the needed information to assign a particular DL (or/and UL) TX beam to the UE. This option is applicable when DL-UL beam pair correspondence holds.

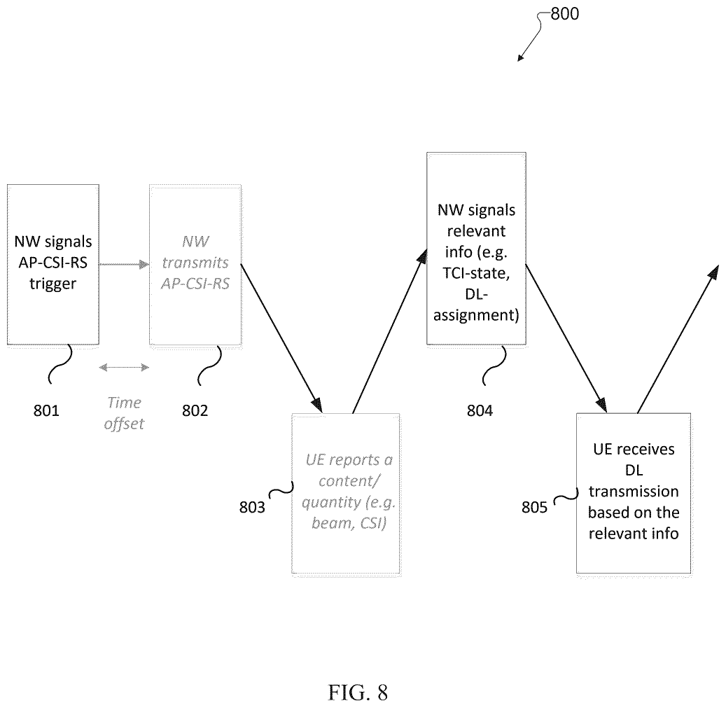

FIG. 8 illustrates a flowchart of an example procedure 800 for DL operation according to embodiments of the present disclosure. For example, procedure 800 can be performed by the UE 116 and the gNB 102 and/or network 130 in the wireless network 100 of FIG. 1. This example is for illustration only and other embodiments can be used without departing from the scope of the present disclosure.

In one example illustrated in FIG. 8 wherein a UE is configured for measuring/receiving aperiodic CSI-RS (AP-CSI-RS) and reporting aperiodic content/quantity (e.g. AP CSI), a procedure 800 for DL operation starts with the gNB/NW signaling to a UE an aperiodic CSI-RS (AP-CSI-RS) trigger or indication (step 801). This trigger or indication can be included in a downlink control information (DCI) (either UL-related or DL-related, either separately or jointly signaled with an aperiodic CSI request/trigger) and indicate transmission of AP-CSI-RS in a same (zero time offset) or later slot/sub-frame (>0 time offset). Upon receiving the AP-CSI-RS transmitted by the gNB/NW (step 802), the UE measures the AP-CSI-RS and, in turn, calculates and reports the content/quantity (step 803). For instance, when content=beam, a “beam metric” indicating quality of a particular TX beam hypothesis is included in the report, and likewise, when content=CSI, precoding matrix indicator (PMI)/channel quality indicator (CQI)/rank indicator (RI) (may also include CQI report interval (CRI), layer index (LI)) indicating DL channel state information is included in the report. For beam, examples of such beam reporting (supported in Rel. 15/16 NR) are CSI-RS resource indicator (CRI) or SSB resource indicator (SSB-RI) coupled with its associated L1-RSRP and/or L1-SINR. Upon receiving the report from the UE, the NW/gNB can use the report to select/indicate relevant information about an upcoming DL (or UL) transmission (step 804). The relevant information can include a DL TX beam for the UE (e.g. using the TCI field in the DL-related DCI that carries the DL assignment, such as DCI format 1_1 in NR) or/and DL assignment. Upon successfully decoding the DL-related DCI, the UE performs DL reception (such as data transmission on physical downlink shared channel (PDSCH)) based on the relevant information provided to the UE (step 805). The aperiodic CSI-RS (along with the associated aperiodic reporting) in procedure 800 can be substituted with that of another time-domain behavior such as semi-persistent (SP) or periodic (P).

The transmission/measurement of the source RS can be dynamically triggered by the NW/gNB (e.g. via DCI in case of aperiodic RS), preconfigured with a certain time-domain behavior (such as periodicity and offset, in case of periodic RS), or a combination of such pre-configuration and activation/deactivation (in case of semi-persistent RS).

In any of the embodiments or sub-embodiments or examples herein, a flowchart is used for illustrative purposes. The present disclosure covers any variation of the flowchart as long as at least some of the components are included.

In one embodiment, a ULE detects (or determines) a need for transmitting a UE-initiated/UE-triggered report (or initiation/triggering) of a (report-)type (A), (B), or (C), where
(A) includes a initiator/trigger/pre-notification message
(B) includes a report/content (comprising one or multiple report quantities)
(C) includes both a trigger/pre-notification message and a (corresponding) report/content

The report is to facilitate/enable efficient/timely/fast/reliable communication over the link/channel between a target entity (e.g. NW/gNB or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ, Jᵢ)}, where Iᵢ is an beam (source RS) indicator (e.g. CRI, SSBRI) and Jᵢ is abeam metric (e.g. L1-RSRP, L1-SINR).
In one example, the content includes CSI-related quantity/quantities. For example, at least one of (RI, PMI, CQI, CRI, LI).
In one example, the content includes time-domain channel property (TDCP)-related quantity/quantities. For example, an indicator about the Doppler profile (e.g. Doppler spread or Doppler shift, relative Doppler spreads, or relative Doppler shifts), or an indicator about the auto-correlation profiles (e.g. (auto-)correlation values corresponding to a few dominant lags/delays).
In one example, the content includes other (e.g. non-beam, non-CSI, non-TDCP) quantity/quantities.
   In one example, quantity/quantities comprises a selector/indicator indicating selection of one (or >1) of either
      beam (TCI state) TCI states (e.g. DL TCI state, UL TCI state, or unified (joint) DL/UL TCI state), or
      panel(s) (e.g. UE panels for DL reception or/and UL transmission), or
      antenna(e) (e.g. UE antennae for DL reception or/and UL transmission), or
      antenna port(s) (e.g. UE antenna ports for DL reception or/and UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g. this switching is for DL reception or/and UL transmission).
In one example, the content includes beam-related quantity/quantities (according to one or more examples described herein) and at least one other quantity/quantities (according to one or more examples described herein).
In one example, the content includes CSI-related quantity/quantities (according to one or more examples described herein) and at least one other quantity/quantities (according to one or more examples described herein).
In one example, the content includes TDCP-related quantity/quantities (according to one or more examples described herein) and at least one other quantity/quantities (according to one or more examples described herein).
In one example, the content includes beam-related quantity/quantities (according to one or more examples described herein) and CSI-related quantity/quantities (according to one or more examples described herein).
In one example, the content includes beam-related quantity/quantities (according to one or more examples described herein) and TDCP-related quantity/quantities (according to one or more examples described herein).
In one example, the content includes TDCP-related quantity/quantities (according to one or more examples described herein) and CSI-related quantity/quantities (according to one or more examples described herein).

In one example, the report is targeting a physical layer (L1) communication (e.g. L1 DL/UL, or L1 sidelink (SL)), i.e. such reporting is to enable fast/reliable DL/UL or SL transmission/reception.

In one example, the link/channel between the target entity and the UE is a Uu interface (i.e. DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e. without being associated with any event) or unconditionally/freely. For example, the UE can be configured with a triggering time window (or multiple UL slots), and the UE can trigger the report during this window.

In one example, such reporting can be event-based, i.e., the UE can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g. beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 2 (for joint) and Table 3/Table 4 (for separate). In these examples, the event-types and the report-types are separate (explicit). However, they can also be joint, as shown in Table 5. A few examples of the autonomous UE-initiated report are shown in Table 6.

TABLE 2
event-based UE-initiated report

| | Report | | |
|---|---|---|---|
| | | Trigger/pre- | |
| Event type | Type | notification message | Content |
| 0: beam | (A) | Yes (e.g. beam-related event) | No |
| | (B) | No | Yes |
| | (C) | Yes (e.g. beam-related event) | Yes |
| 1: CSI | (A) | Yes (e.g. CSI-related event) | No |
| | (B) | No | Yes |
| | (C) | Yes (e.g. CSI-related event) | Yes |
| 2: TDCP | (A) | Yes (e.g. TDCP-related event) | No |
| | (B) | No | Yes |
| | (C) | Yes (e.g. TDCP-related event) | Yes |
| 3: non-CSI/beam/ | (A) | Yes (e.g. non-CSI-related event) | No |
| TDCP | (B) | No | Yes |
| | (C) | Yes (e.g. non-CSI-related event) | Yes |
| 4. other (content- | (A) | Yes (no need for content) | No |
| free/less events) | | | |

TABLE 3
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 4

| | Trigger/pre- | |
|---|---|---|
| Report-type | notification message | Content |
| (A) | Yes | No |
| (B) | No | Yes |
| (C) | Yes | Yes |

TABLE 5
event-based UE-initiated report
Report

| | Trigger/pre- | |
|---|---|---|
| Type | notification message | Content |
| 0 | Yes (e.g. beam-related event), | No |
| | content-specific or event-specific | |
| 1 | No | Beam |
| 2 | Yes (e.g. beam-related event) | Beam |
| 3 | Yes (e.g. CSI-related event) | No |
| 4 | No | CSI |
| 5 | Yes (e.g. CSI-related event) | CSI |
| 6 | Yes (e.g. TDCP-related event) | No |
| 7 | No | TDCP |
| 8 | Yes (e.g. TDCP-related event) | TDCP |
| 9 | Yes (e.g. non-CSI-related event) | No |
| 10 | No | Non-CSI |
| 11 | Yes (e.g. non-CSI-related event) | Non-CSI |

TABLE 6
non-event-based or autonomous UE-initiated report
Report

| | Trigger/pre- | |
|---|---|---|
| Type | notification message | Content |
| 0 | Yes (content- | No |
| | agnostic/transparent) | |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

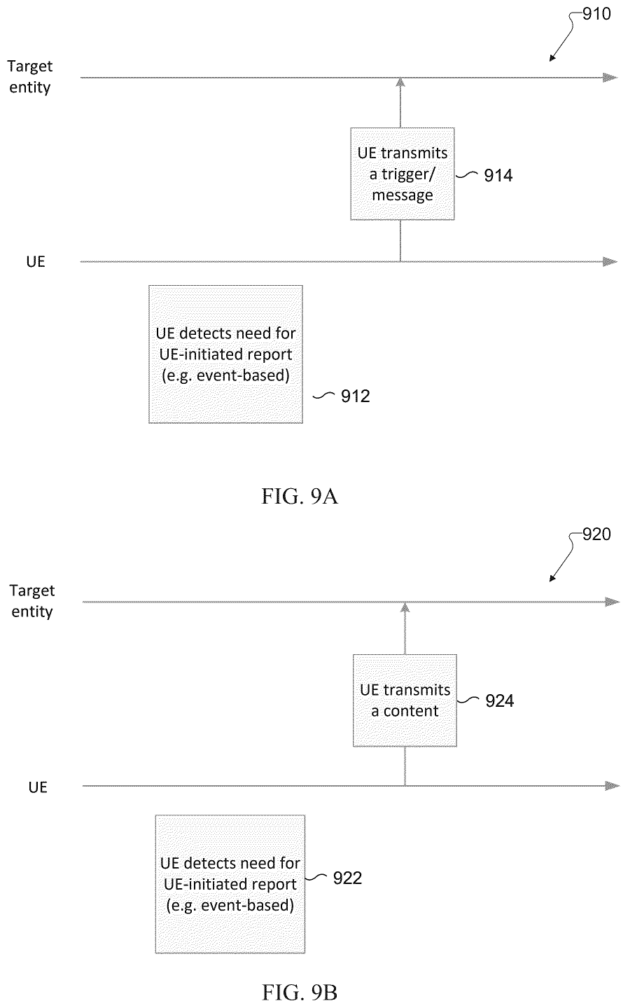

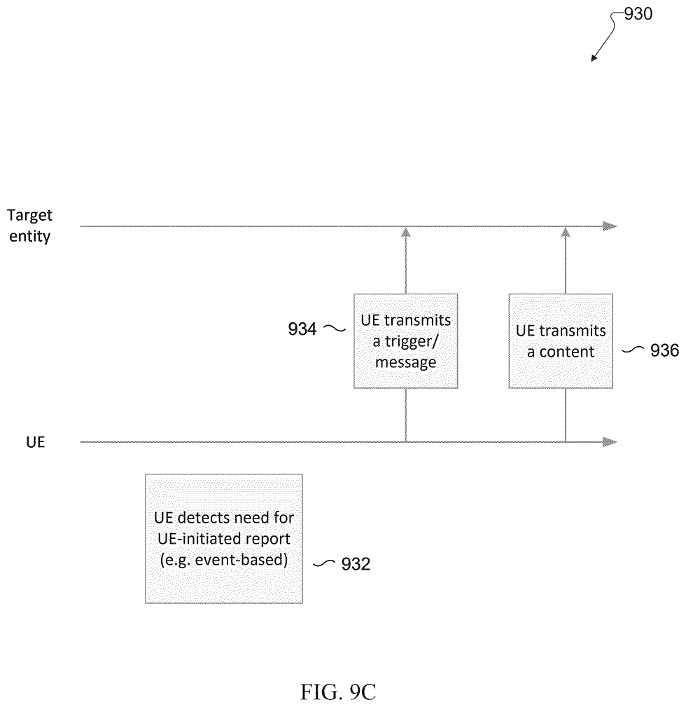

FIGS. 9A, 9B, and 9C illustrate signal flows 910, 920, and 930, respectively, of example procedures for UE transmission according to embodiments of the present disclosure. For example, signal flows 910, 920, and 930, respectively, can be performed by the UE 116 and the gNB 102 and/or network 130 in the wireless network 100 of FIG. 1. This example is for illustration only and other embodiments can be used without departing from the scope of the present disclosure.

The procedure 910 beings in 912, a UE detects need for UE-initiated report (e.g. event-based). In 914, the UE transmits a trigger/message to a NW.

The procedure 920 begins in 922, a UE detects need for UE-initiated report (e.g. event-based). In 924, the UE transmits a content to a NW.

The procedure 930 begins in 932, UE detects need for UE-initiated report (e.g. event-based). In 934, the UE transmits a trigger/message to a NW. In 936, the UE transmits a content to the NW.

In one example, as shown in FIG. 9, there is no configuration from the NW/gNB to the UE, and the UE, on detecting a need, is free to trigger/initiate the report, and transmit a trigger/message, e.g. a report request via scheduling request (SR), or UCI, or random access channel (RACH) message. The UE can also transmit the report content via UL resource/channel (configured or granted) for the report. The UL resource/channel can be granted to the UE via DCI or/and MAC—control element (CE). Some information about the UE-initiated report can also be reported by the UE, e.g. via the trigger/message, where the information is according to at least one of the examples described herein.

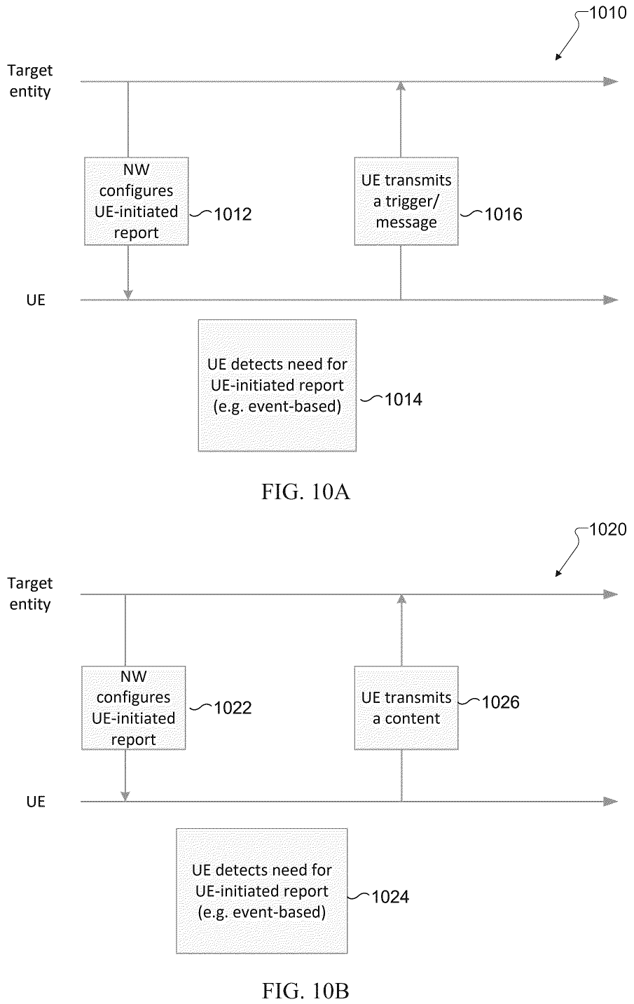

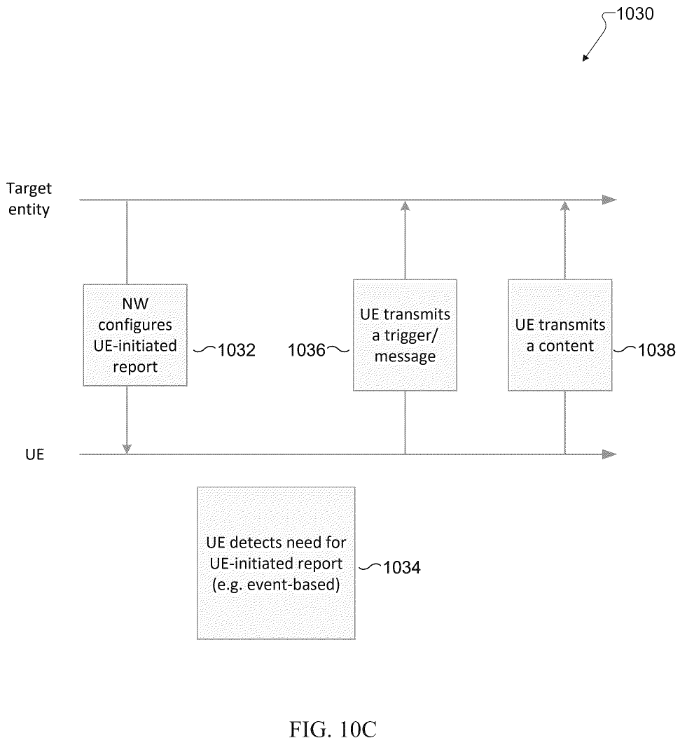

FIGS. 10A, 10B, and 10C illustrate signal flows 1010, 1020, and 1030, respectively, of example procedures for UE transmission according to embodiments of the present disclosure. For example, signal flows 1010, 1020, and 1030, respectively, can be performed by the UE 116 and the gNB 102 and/or network 130 in the wireless network 100 of FIG. 1. This example is for illustration only and other embodiments can be used without departing from the scope of the present disclosure.

The procedure 1010 begins in 1012, a NW configures UE-initiated report and then transmits the UE-initiated report configuration to a UE. In 1014, the UE detects need for UE-initiated report (e.g. event-based). In 1016, the UE transmits a trigger/message to the NW.

The procedure 1020 begins in 1022, a NW configures UE-initiated report and then transmits the UE-initiated report configuration to a UE. In 1024, the UE detects need for UE-initiated report (e.g. event-based). In 1026, the UE transmits a content to the NW.

The procedure 1030 begins in 1032, a NW configures UE-initiated report and then transmits the UE-initiated report configuration to a UE. In 1034, the UE detects need for UE-initiated report (e.g. event-based). In 1036, the UE transmits a trigger/message to the NW. In 1038, the UE transmits a content to the NW.

In one example, as shown in FIG. 10, the UE can be configured with the UE-initiated report (e.g. via RRC), and only then the UE, on detecting a need, can trigger/initiate the report, and transmit a trigger/message, e.g. a report request via SR, or UCI, or RACH message. The UE can also transmit the report content via UL resource/channel (configured or granted) for the report. The UL resource/channel can be granted to the UE via DCI or/and MAC-CE.

In one embodiment, the report can be associated with (or linked to) a measurement procedure. The timing of this measurement can be aperiodic (AP), or semi-persistent (SP), or periodic (P). The measurement procedure can be based on according to at least one of the following:
In one example, it is based on one or multiple reference signal (RS) resources such as DL RS resource (e.g. NZP CSI-RS or SSB or DL demodulation reference signal (DMRS) or tracking RS), UL RS (e.g. SRS or UL DMRS), or SL RS (e.g. SL CSI-RS or SL DMRS).
In one example, it is based on one or multiple reference signal (RS) resource sets (comprising one or multiple RS resources).
In one example, it is based on one or multiple antenna groups.
In one example, it is based on one or multiple antenna port groups.
In one example, it is based on one or multiple TRPs or remote radio heads (RRHs).
In one example, it is based on one or multiple antenna panels.

In one example, this association between the report and the measurement procedure is provided/configured (by NW) or/and initiated by the UE (e.g., the UE 116) (together or separate from the UE-initiated report) only when the report needs to include the content, i.e., report-types (B) or (C).

In one example, the report can be an AP report. In one example, the report can be a SP report (i.e. comprising multiple instances of the same report-type, each instance is a self-contained/independent report content).

In one embodiment, for (C), the content can be transmitted/reported in one-shot (in one part) in an UL slot with the UL resources for reporting the content.
In one example, the trigger/message and the content are transmitted together in the same slot.
In one example, the trigger/message and the content are transmitted in two different UL slots. The offset between the two slots can be fixed, or determined implicitly (without any signaling), or determined based on signaling from the target entity (it is provided via RRC, or MACE CE, or DCI).

In one embodiment, for (C), the content can be transmitted/reported in two parts. The content can be divided into two (part 1 and part 2).
In one example, part 1 and the trigger/message are multiplexed together (e.g. UCI part 1), and part 2 is separate (e.g. UCI part 2), and they are transmitted in the same slot (e.g. via two-part UCI).
In one example, part 1 and the trigger/message are multiplexed together (e.g. UCI part 1), and part 2 is separate (e.g. UCI part 2), and they are transmitted in the two different slots. The offset between the two slots can be fixed, or determined implicitly (without any signaling), or determined based on signaling from the target entity (it is provided via RRC, or MACE CE, or DCI).
In one example, part 1 and part 2 are multiplexed in UCI part 1 and UCI part 2 of a two-part UCI, which is transmitted in a slot different from the slot for the trigger/message. The offset between the two slots can be fixed, or determined implicitly (without any signaling), or determined based on signaling from the target entity (it is provided via RRC, or MACE CE, or DCI).
In one example, part 1 and part 2 are multiplexed in UCI part 1 and UCI part 2 of a two-part UCI, which is transmitted in a slot that also carried the trigger/message.

In an example herein, part 2 (of the content) can be absent (not reported). The information on whether it is reported or absent can be reported in part 1 (of the content), e.g. via a UCI parameter such as 1-bit indicator. Or, the information on whether it is reported or absent can be determined implicitly based on part 1 (of the content), e.g. after decoding part 1. When part 2 is reported, the UL resource for part 2 can be pre-configured (e.g. with that for part 1), or can be requested via part 1 (or trigger/message).

When there are multiple report-types, the UE can report contents for both report-types.
In one example, one content is included in part 1 and another content is included in part 2.
In one example, subset 1 of both contents are included in part 1 and subset 2 of both contents are included in part 2.

Or, when there are multiple report-types, UE can select one of the report-types, and transmit content for the selected report-type. The selection can be fixed (based on a priority order), or can be based on a configuration, or reported by the UE (e.g. via part 1).

Or, when there are multiple report-types, UE can select n out of N report-types, and transmit content for the selected n report-type, where 1≤n≤N. The selection of n report-types can be fixed (based on a priority order), or can be based on a configuration, or reported by the UE (e.g. via part 1).

When the UL resources for reporting part 1 and part 2 of the content(s) of report-type(s) is not sufficient (i.e., the number of information bits to report contents is more than the number of information bits allocated for the UL resources), the UE omits (not report) part 2, or a portion of the part 2. In one example, this omission procedure is the same as in Rel. 15-17 NR [5.2.3, [REF 4]]. In particular, part 2 of a content can be further partitioned into multiple groups (e.g. 3), and the omission procedures happens according to a priority order of the multiple groups. In one example, part 1 of report-types are grouped together in one group (G0) which has the highest priority (assuming omission order is low/to high). In one example, the number of groups for a content can be the same for report-types (e.g. 2 or 3 for all). In one example, the number of groups for a content can be different and depends on the report-types (e.g. one group for one report-type, 2 groups for another report-type, 3 for another report-type). In one example, the number of groups for a content can be configured to the UE (e.g. RRC) or together with signaling for the UL resources. In one example, the number of groups for a content can be reported by the UE (e.g. via part 1).

In one embodiment, for (B), the content can be transmitted/reported according to at least one of the following example.
In one example, the content can be transmitted/reported in one-shot (in one part) in an UL slot with the UL resources for reporting the content.
In one example, the content can be transmitted/reported in two parts. The content can be divided into two (part 1 and part 2). In one example, part 1 and part 2 are multiplexed in UCI part 1 and UCI part 2 of a two-part UCI, which is transmitted in one slot.

In an example herein, part 2 (of the content) can be absent (not reported). The information on whether it is reported or absent can be reported in part 1 (of the content), e.g. via a UCI parameter such as 1-bit indicator. Or, the information on whether it is reported or absent can be determined implicitly based on part 1 (of the content), e.g. after decoding part 1. When part 2 is reported, the UL resource for part 2 can be pre-configured (e.g. with that for part 1), or can be requested via part 1.

When there are multiple report-types, the UE can report contents for both report-types.
In one example, one content is included in part 1 and another content is included in part 2.
In one example, subset 1 of both contents are included in part 1 and subset 2 of both contents are included in part 2.

Or, when there are multiple report-types, UE can select one of the report-types, and transmit content for the selected report-type. The selection can be fixed (based on a priority order), or can be based on a configuration, or reported by the UE (e.g. via part 1).

Or, when there are multiple report-types, UE can select n out of N report-types, and transmit content for the selected n report-type, where 1≤n≤N. The selection of n report-types can be fixed (based on a priority order), or can be based on a configuration, or reported by the UE (e.g. via part 1).

When the UL resources for reporting part 1 and part 2 of the content(s) of report-type(s) is not sufficient (i.e., the number of information bits to report contents is more than the number of information bits allocated for the UL resources), the UE omits (not report) of part 2, or a portion of the part 2. In one example, this omission procedure is the same as in Rel. 15-17 NR [5.2.3, [REF 4]]. In particular, part 2 of a content can be further partitioned into multiple groups (e.g. 3), and the omission procedures happens according to a priority order of the multiple groups. In one example, part 1 of report-types are grouped together in one group (G0) which has the highest priority (assuming omission order is low/to high). In one example, the number of groups for a content can be the same for report-types (e.g. 2 or 3 for all). In one example, the number of groups for a content can be different and depends on the report-types (e.g. one group for one report-type, 2 groups for another report-type, 3 for another report-type). In one example, the number of groups for a content can be configured to the UE (e.g. RRC) or together with signaling for the UL resources. In one example, the number of groups for a content can be reported by the UE (e.g. via part 1).

In one embodiment, the number of parts (one part or two parts) for a content can be the same for report-types (e.g. 1 or 2 for all). In one example, the number of parts for a content can be different and depends on the report-types (e.g. one part for one report-type, 2 parts for another report-type). In one example, the number of parts for a content can be configured to the UE (e.g. RRC) or together with signaling for the UL resources. In one example, the number of parts for a content can be reported by the UE (e.g. via part 1).

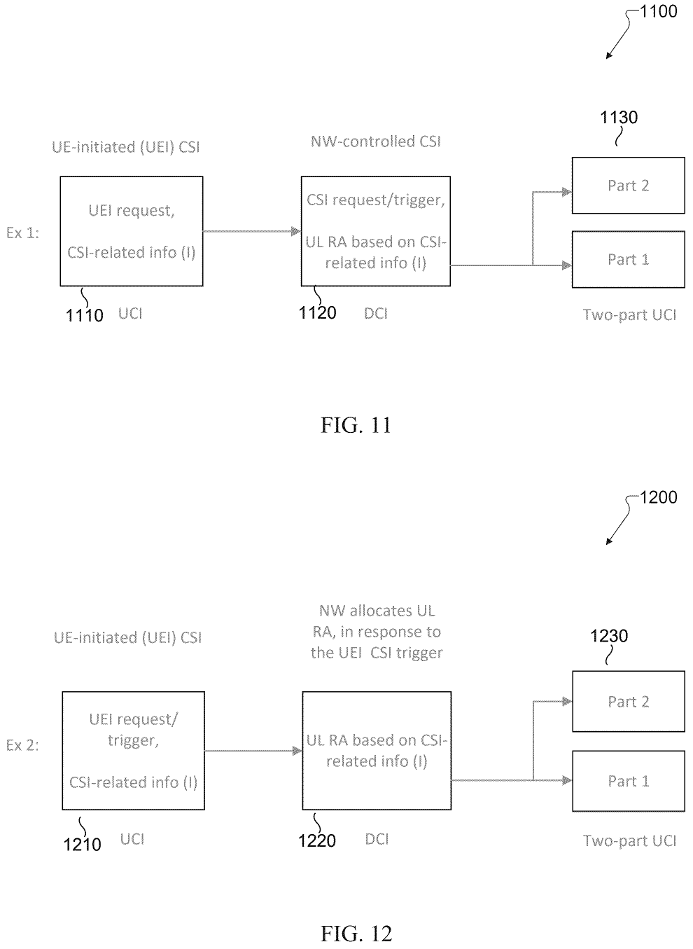

FIG. 11 illustrates an example procedure 1100 for configuring a two-part UCI according to embodiments of the present disclosure. For example, procedure 1100 can be performed by the UE 111 and the gNB 102 and/or network 130 in the wireless network 100 of FIG. 1. This example is for illustration only and other embodiments can be used without departing from the scope of the present disclosure.

In one embodiment, a UE determines/detects a need for transmitting UEI CSI report(s), and transmits a UCI including UEI request/message and a CSI-related info (I) 1110. The NW decodes the UCI and can respond to the UEI request/message. This response can be via a DCI (e.g. UL-related DCI), which includes UL RA that is based on the CSI-related info (I) 1120 and is for a two-part UCI 1130. The DCI may also include a CSI request/trigger field (cf. FIG. 11) that indicates a CSI trigger state from the list of CSI trigger states configured via higher layer (optionally together with MAC CE activation/deactivation), i.e. the triggering of CSI report(s) is NW-controlled via DCI.

FIG. 12 illustrates an example procedure 1200 for configuring a two-part UCI according to embodiments of the present disclosure. For example, procedure 1200 can be performed by the UE 116 and the gNB 102 and/or network 130 in the wireless network 100 of FIG. 1. This example is for illustration only and other embodiments can be used without departing from the scope of the present disclosure.

In one embodiment, a UE determines/detects a need for transmitting UEI CSI report(s), and transmits a UCI including UEI request/trigger and a CSI-related info (I) 1210. Alternatively, as shown in FIG. 12, the NW can allocate UL RA without any CSI trigger/request (in DCI), in response to the UCI (UEI request or/and CSI-related info (I)) 1220, i.e., the triggering of CSI report(s) is based on UE-initiated via UCI 1230. For instance, UCI can include a parameter to indicate a CSI trigger state or ID(s) of CSI report(s).

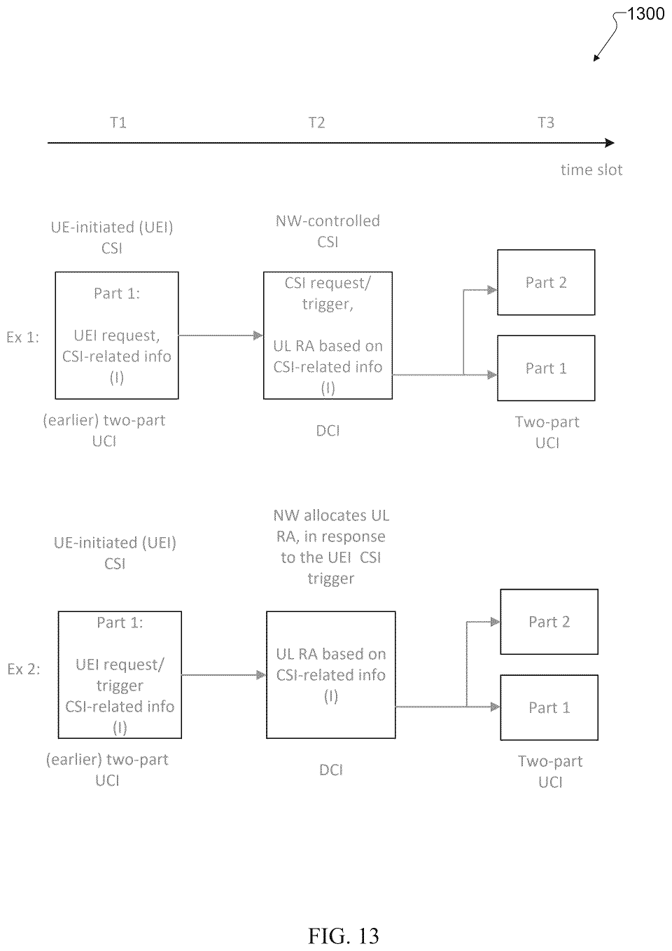

FIG. 13 illustrates example timelines 1300 for configuring a two-part UCI according to embodiments of the present disclosure. For example, timelines 1300 can be followed by the UE 114 and the gNB 102 and/or network 130 in the wireless network 100 of FIG. 1. This example is for illustration only and other embodiments can be used without departing from the scope of the present disclosure.

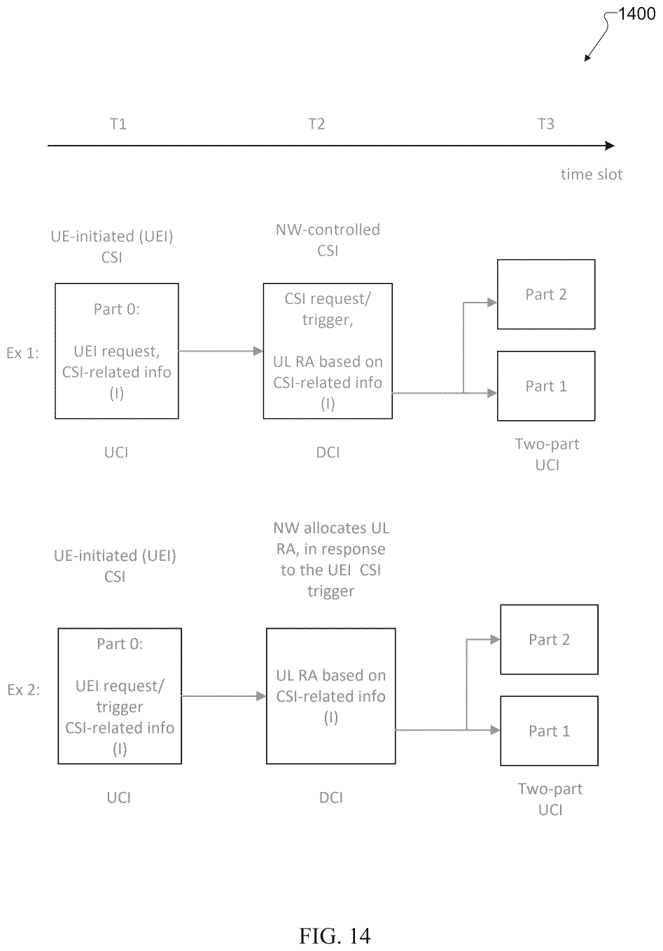

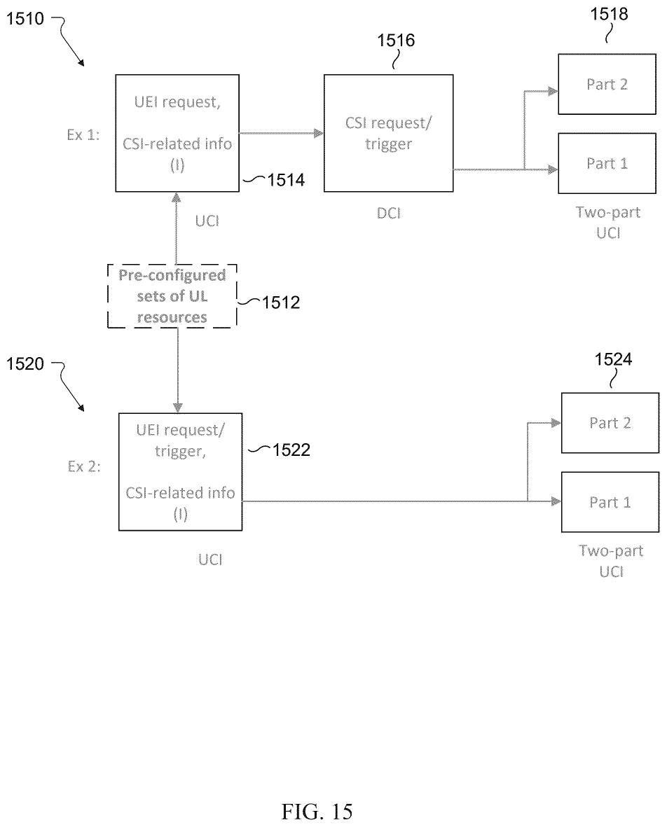

FIG. 14 illustrates example timelines 1400 for configuring a two-part UCI according to embodiments of the present disclosure. For example, timelines 1400 can be followed by the UE 116 and the gNB 102 and/or network 130 in the wireless network 100 of FIG. 1. This example is for illustration only and other embodiments can be used without departing from the scope of the present disclosure.

In one example, the UCI with the CSI-related info (I) or/and UEI request/trigger can be included in (or transmitted via) a previous (another/earlier) two-part UCI. For instance, the UCI with the CSI-related info (I) can be included in part 1 of the previous (another/earlier) two-part UCI, as shown in FIG. 13, for the two examples (Ex 1 and Ex 2) explained herein.

In one example, the UCI has three parts, one part before DCI and two parts after DCI, as shown in FIG. 14.

In one example, an existing UCI parameter/field (e.g. SR) can be used or repurposed for UEI request. Note that there is no separate scheduling request per se from the UE. It is rather implicit.

In one example, an existing UCI parameter/field (e.g. SR) can be used or repurposed for CSI-related info (I), i.e., the existing UCI parameter/field is used to provide NW a cue/info about CSI, e.g. the payload of CSI report(s). Note that there is no separate scheduling request per se from the UE. It is rather implicit.

In one example, an existing UCI parameter/field (e.g. SR) can be used or repurposed for UEI request and CSI-related info (I), i.e., the existing UCI parameter/field is used to provide NW a cue/info about CSI, e.g. the payload of CSI report(s). Note that there is no separate scheduling request per se from the UE. It is rather implicit.

In one example, the UCI includes SR and the CSI-related info (I), where the CSI-related info provides information about the payload of CSI report(s). Note that there is scheduling request from the UE, and there is CSI-related info additionally. In one example, the payload information corresponds to a B-bit indicator. In one example, B=1 (BPSK) indicating one of 2 payload sizes. In one example, B=2 (QPSK) indicating one of 4 payload sizes. In one example, B=1 indicating one of 2 cyclic shifts (CSs or payload sizes). In one example, B=2 indicating one of 4 CSs (or payload sizes).
In one example, the SR is about the CSI report(s). In this case, the SR can also act as UEI request/trigger.
In one example, the SR is about UL data (PUSCH) transmission. In this case, the SR is separate/independent from the UEI request and CSI-related info.
In one example, the SR can be about both CSI report(s) and UL data (PUSCH).

In one example, the UCI includes one (joint) field that takes a value from {(v1, −), (−, v2), (v1, v2)}, where SR=v1 and CSI-related info=v2.

When CSI-related info (I) is about multiple CSI reports,
In one example, the CSI-related info (I) is common (the same) for the multiple CSI reports.
In one example, the CSI-related info (I) is independent (separate) for each of the multiple CSI reports.

FIG. 15 illustrates example procedures 1510 and 1520 for configuring a two-part UCI according to embodiments of the present disclosure. For example, procedure 1510 can be performed by the UE 116 and the gNB 102 and/or network 130 in the wireless network 100 of FIG. 1. For example, procedure 1520 can be performed by the UE 116 of FIG. 3. These examples are for illustration only and other embodiments can be used without departing from the scope of the present disclosure.

The procedure 1510 begins in 1512, pre-configured sets of UL resources can be provided. In 1514, a UEI request and CSI-related info (I) is provided via UCI. In 1516, a CSI request/trigger is provided via DCI. In 1518, a two-part UCI is provided.

The procedure 1520 begins in 1512, pre-configured sets of UL resources can be provided. In 1522, a UEI request/trigger and CSI-related info (I) is provided via UCI. In 1524, a two-part UCI is provided.

In a variation of this embodiment, as shown in FIG. 15, the UL RA is pre-configured, hence there is no need for UL RA via DCI as in FIG. 11 through FIG. 14. This DCI is either not needed (Ex 2), or is still used for the case when NW still triggers the CSI report(s) (Ex 1). The SR or/and UEI trigger/request is a type of pre-notification (PN). There can be multiple sets of pre-configured UL resources (for two-part UCI), and SR/PN can indicate one of them for the two-part UCI. For example, when B=1 bit for SR/PN, there are two set of UL resources, when B=2 bits, there are four sets of UL RA resources, and so on.

In one example, at least one of the following examples is used/configured regarding CSI-related info (I).

In one example, the CSI-related info (I) includes info about rank of CSI report(s).
In one example, the CSI-related info (I) includes RI(s) or recommended RI value(s) of CSI report(s). The RI(s) can be based on (subject to) RI/rank-restrictions (via higher layer). In one example, RI(s) indicates one of allowed rank value(s) of CSI report(s).
In one example, the CSI-related info (I) includes rank value(s) or recommended rank value(s) of CSI report(s). The rank value(s) can be based on (subject to) RI/rank-restriction (via higher layer).
In one example, the CSI-related info (I) includes a maximum rank value(s) or recommended maximum rank value(s) of CSI report(s). The maximum rank value(s) can be based on (subject to) RI/rank-restriction (via higher layer).

In one example, the CSI-related info (I) includes info about number of non-zero (NZ) coefficients (K^{NZ}) reported via CSI report(s). For example, when the CSI report(s) are based on linear combination/summation (LC) precoding, where LC is based on (1) basis vectors, and (2) coefficients (e.g. Type II codebooks in 5G NR).
In one example, the CSI-related info (I) includes K^{NZ} value(s) or recommended K^{NZ} value(s) of CSI report(s).
In one example, the CSI-related info (I) includes maximum K^{NZ} value(s) or recommended maximum K^{NZ} value(s) of CSI report(s).
In one example, the CSI-related info (I) includes β value(s) or recommended β value(s) that provide an upper bound (max value) on K^{NZ} value(s).

In one example, the CSI-related info (I) includes info about RI/rank and K^{NZ} value(s) of CSI report(s), where RI/rank and K^{NZ} value(s) corresponds to one or more of the examples herein.

In one example, the CSI-related info (I) includes info about CQI value(s) of CSI report(s).
In one example, the CSI-related info (I) includes the number of CQI value(s).
In one example, when CQI frequency granularity is SB, the CSI-related info (I) includes the number of SB CQI value(s).
In one example, the CSI-related info (I) includes the maximum number of CQI value(s).
In one example, when CQI frequency granularity is SB, the CSI-related info (I) includes the maximum number of SB CQI value(s).

In one example, the CSI-related info (I) includes info about CQI value(s) and RI/rank value(s) of CSI report(s), where RI/rank and K^{NZ} value(s) corresponds to one or more examples described herein.

In one example, the CSI-related info (I) includes info about CQI value(s) and K^{NZ} value(s) of CSI report(s), where RI/rank and K^{NZ} value(s) corresponds to one or more examples described herein.

In one example, the CSI-related info (I) includes info about CQI value(s), RI/rank value(s), and K^{NZ} value(s) of CSI report(s), where RI/rank and K^{NZ} value(s) corresponds to one or more examples described herein.

In one example, the CSI-related info (I) includes info about CRI value(s) of CSI report(s).
In one example, the CSI-related info (I) includes a (total) number of CRI value(s) across CSI report(s).
In one example, the CSI-related info (I) includes a number of CRI value(s) for each of the CSI report(s).
In one example, the CSI-related info (I) includes a number of CRI value(s) for a subset of the CSI report(s). In one example, the subset corresponds to the CSI report(s) configured with multiple measurement RSs (e.g. NZP CSI-RS).
In one example, the CSI-related info (I) includes a maximum (total) number of CRI value(s) across CSI report(s).
In one example, the CSI-related info (I) includes a maximum number of CRI value(s) for each of the CSI report(s).
In one example, the CSI-related info (I) includes a maximum number of CRI value(s) for a subset of the CSI report(s). In one example, the subset corresponds to the CSI report(s) configured with multiple measurement RSs (e.g. NZP CSI-RS).

In one example, the CSI-related info (I) includes info about CRI value(s) and RI/rank value(s) of CSI report(s), where details are according to one or more examples described herein.

In one example, the CSI-related info (I) includes info about CRI value(s) and K^{NZ} value(s) of CSI report(s), where details are according to one or more examples described herein.

In one example, the CSI-related info (I) includes info about CRI value(s) and CQI value(s) of CSI report(s), where details are according to one or more examples described herein.

In one example, the CSI-related info (I) includes info about CRI value(s), RI/rank, and K^{NZ} value(s) of CSI report(s), where details are according to one or more examples described herein.

In one example, the CSI-related info (I) includes info about CRI value(s), RI/rank, and CQI value(s) of CSI report(s), where details are according to one or more examples described herein.

In one example, the CSI-related info (I) includes info about CRI value(s), K^{NZ} and CQI value(s) of CSI report(s), where details are according to one or more examples described herein.

In one example, the CSI-related info (I) includes info about CRI value(s), RI/rank, K^{NZ} and CQI value(s) of CSI report(s), where details are according to one or more examples described herein.

In one example, the CSI-related info (I) includes info about at least one UCI/CSI parameter in UCI/CSI part 1 (of a two-part UCI/CSI).
In one example, it includes info about the rank indicator (RI) or rank value.
   In one example, it is about one rank or RI value.
   In one example, it is about maximum rank or RI value.
   In one example, it is about recommended RI or rank value(s). In one example, this is akin to (can be referred to as) the UEI rank/RI restriction.
   In one example, it is according to one or more examples described herein.
In one example, it includes info about the number of NZ coefficients.
   In one example, it is according to one or more examples described herein.
In one example, it includes info about the CQI value(s).
In one example, it includes info about the CRI value(s).
In one example, it includes info about at least two from RI/rank, K^{NZ}, CQI, and CRI value(s), where details are according to one or more examples described herein.

In one example, the CSI-related info (I) includes info about at least one of the following codebook parameters.
In one example, it is about β value(s), which determines an upper bound (max value) on K^{NZ}. For example,

$${K}^{NZ} = ⌈ β X ⌉ , where X = 2 {LM}_{v} or {K}_{1} {M}_{v} or {\sum }_{r = 1}^{N} 2 {L}_{r} {M}_{v}$$

(when CSI corresponds to coherent joint transmission (CJT) CSI across N NZP CSI-RSs)
In one example, it is about parameter combination value(s), for example, (L, M_{υ}, β) or (L, p_{υ}, β) or (α, M, β) or (α, p, β), where

$${M}_{v} = ⌈ \frac{{p}_{v} {N}_{3}}{R} ⌉ , L = ⌈ \frac{α {P}_{CSIRS}}{2} ⌉ ,$$

and υ denotes number of layers, as in 5.2.2.2.5 through 5.2.2.2.11 of [REF 4].
In one example, it is about L or {Lᵣ} value(s) for number of spatial domain (SD) vectors.
In one example, it is about M_{υ} value(s) for number of frequency domain (FD) vectors.
In one example, it is about Q value(s) for number of delay domain (DD)/time domain (TD) vectors.

In one example, M_{υ}=M when number of FD basis vectors is the same (common) across number of layers (or rank values). In one example, K₁=2L.

In one example, the CSI-related info (I) includes info about Type II coherent joint transmission (CJT) CSI across multiple TRPs (or NZP CSI-RSs).
In one example, it is about a TRP (or NZP CSI-RS resource) selection. For example, a length Nₜᵣₚ bit sequence indicating N selected TRP(s) from the Nₜᵣₚ configured TRPs. Here, a TRP can corresponds to at least one NZP CSI-RS or at least one group of NZP CSI-RS ports.
In one example, it is about N_{L} value(s) where N_{L} is a number of combinations {(L₁, . . . Lₜᵣₚ)}. For example, one out of N_{L} configured combinations {(L₁, . . . Lₜᵣₚ)}, where Lᵣ is associated with TRP r, can be included in CSI-related info.

In one example, the CSI-related info (I) includes info about codebook type (e.g. Type I, Type II, Type II CJT, Type Doppler and so on).

In one example, the CSI-related info (I) can also include an ID of a CSI report, or include ID(s) of CSI report(s). The included ID(s) corresponds to ID(s) of CSI report(s) whose CSI(s) are triggered by UEI trigger.

In one example, the UL channel(s) for carrying the UCI (with UEI CSI trigger and/or CSI-related info) and the two-part UCI (for CSI report(s)) is according to at least one of the following examples.
In one example, the UL channel(s) for both is the same PUSCH (both CG or DG PUSCHs).
In one example, the UL channel(s) for the UCI (with UEI CSI trigger and/or CSI-related info) is a configured grant (CG) PUSCH (i.e. RRC-configured PUSCH), and that for the two-part UCI (for CSI report(s)) is a dynamic grant (DG) PUSCH (i.e. DCI-triggered UL grant).
In one example, the UL channel(s) for the UCI (with UEI CSI trigger and/or CSI-related info) is physical uplink control channel (PUCCH), and that for the two-part UCI (for CSI report(s)) is a dynamic grant (DG) PUSCH (i.e. DCI-triggered UL grant).
In one example, the UL channel(s) for the UCI (with UEI CSI trigger and/or CSI-related info) is physical random access channel (PRACH), and that for the two-part UCI (for CSI report(s)) is a dynamic grant (DG) PUSCH (i.e. DCI-triggered UL grant). In one example, the type of PRACH is contention-based (CB), i.e., contention-based random access (CBRA). In one example, the type of PRACH is non-contention-based (contention free, CF), i.e., contention-free random access (CFRA). In one example, the type of PRACH is contention-based or non-contention-based. In one example, the UCI (with UEI CSI trigger and/or CSI-related info) is included in Msg 1 (preamble) or Msg 3 (PUSCH) or hybrid automatic repeat request acknowledgement (HARQ ACK)/negative ACK (NACK) of Msg 4 of RACH procedure.
In one example, the UCI can also include HARQ-ACK, link recovery request (as defined in clause 9.2.4 of [REF 3]) and/or SR. This can be transmitted via PUCCH.
In one example, the UCI can also include HARQ-ACK/positive SR/RI/CRI/SSBRI and/or PRACH. This can be transmitted via PUSCH/PUCCH.

In one example, the UCI omission procedure as described herein can be simplified (when compared with UCI omission in 5G NR, cf. Section 5.2.3 of [REF 4]).

In one example, there is no FD permutation, i.e., π(f)=f when UCI part 2 is partitioned into (G0, G1, G2), as described in Section 5.2.3 of [REF 4].

In one example, the UCI part 2 can be one group, i.e., G0, G1, G2 can be lumped into one.

In one example, the UCI part 2 can be divided into two groups.
In one example, there is no partition of NZ coefficients and bitmap, i.e., (G1, G2) can be lumped into one.
In one example, there is no partition of NZ coefficients and bitmap, i.e., (G0, G1) can be lumped into one.

In one example, the UCI part 2 is partitioned into (G0, G1, G2), however, their content can be multiplexed with

In one example, there is at least one of the following restrictions/conditions on CSI report(s) with large payload variations under which the CSI-related info (I) is included in the UCI.
In one example, the restriction/condition corresponds to L>1.
In one example, the restriction/condition corresponds to a CJT CSI with TRP selection ON (e.g. via higher layer).
In one example, the restriction/condition corresponds to the case when multiple allowed rank values (e.g. via RI restriction).
In one example, the restriction/condition corresponds to the case when allowed rank values belong to a set, e.g. {1,2}
In one example, the restriction/condition corresponds to the case when allowed rank values >t₁.
In one example, the restriction/condition corresponds to the case when allowed rank values ≤t₂.

Here, t₁ and t₂ are thresholds which can be fixed or configured.

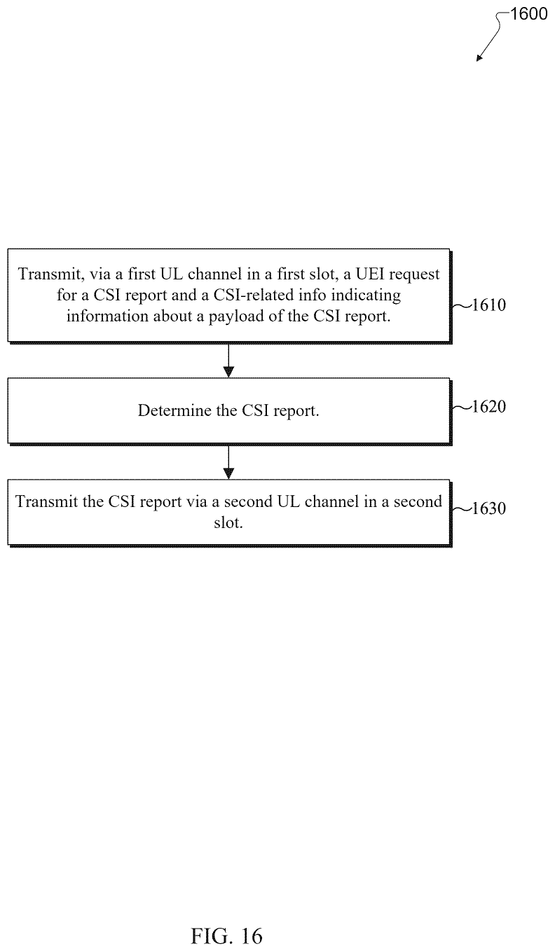

FIG. 16 illustrates an example method 1600 performed by a UE in a wireless communication system according to embodiments of the present disclosure. The method 1600 of FIG. 16 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1600 is for illustration only and other embodiments can be used without departing from the scope of the present disclosure.

The method 1600 begins with the UE transmitting, via a first UL channel in a first slot, a UEI request for a CSI report and a CSI-related info indicating information about a payload of the CSI report (1610). For example, in 1610, the CSI-related info includes information about at least one RI or rank value. The at least one RI or rank value indicates the information about the payload of the CSI report. In various embodiments, the CSI-related info includes an information about a number of non-zero coefficients and the number of non-zero coefficients indicates the information about the payload of the CSI report. In various embodiments, the CSI-related info includes information about a pre-configured set of UL resources for the second UL channel from multiple pre-configured sets of UL resources. In various embodiments, the first UL channel is a PUCCH.

The UE then determines the CSI report (1620). For example, in 1620, the CSI report is included in UCI. The UCI is a two-part UCI comprising a UCI part 1 and a UCI part 2. The UCI part 1 includes a CSI part 1. The UCI part 2 includes a CSI part 2. The CSI part 1 and the CSI part 2 are two parts of the CSI report.

The UE then transmits the CSI report via a second UL channel in a second slot (1630). For example, in 1630, the second UL channel is a PUSCH. In various embodiments, the UE may receive a response to the UEI request via a DCI. The response includes at least one of a CSI request and an UL resource based on the CSI-related info.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to transmit, via a first uplink (UL) channel in a first slot, (i) a UE initiated (UEI) request for a channel state information (CSI) report and (ii) a CSI-related info indicating information about a payload of the CSI report; and
a processor operably coupled to the transceiver, the processor configured to determine the CSI report,
wherein the transceiver is further configured to transmit the CSI report via a second UL channel in a second slot.

2. The UE of claim 1, wherein:
the transceiver is further configured to receive a response to the UEI request via a downlink control information (DCI), and
the response includes at least one of a CSI request and an UL resource based on the CSI-related info.

3. The UE of claim 1, wherein:
the CSI-related info includes information about at least one rank indicator (RI) or rank value, and
the at least one RI or rank value indicates the information about the payload of the CSI report.

4. The UE of claim 1, wherein:
the CSI-related info includes an information about a number of non-zero coefficients, and
the number of non-zero coefficients indicates the information about the payload of the CSI report.

5. The UE of claim 1, wherein:
the CSI report is included in uplink control information (UCI),
the UCI is a two-part UCI comprising a UCI part 1 and a UCI part 2,
the UCI part 1 includes a CSI part 1,
the UCI part 2 includes a CSI part 2, and
the CSI part 1 and the CSI part 2 are two parts of the CSI report.

6. The UE of claim 1, wherein the CSI-related info includes information about a pre-configured set of UL resources for the second UL channel from multiple pre-configured sets of UL resources.

7. The UE of claim 1, wherein the first UL channel is a physical uplink control channel (PUCCH).

8. The UE of claim 1, wherein the second UL channel is a physical downlink shared channel (PUSCH).

9. A base station (BS) comprising:
a processor; and
a transceiver operably coupled to the processor, the transceiver configured to:
receive, via a first uplink (UL) channel in a first slot, (i) a UE initiated (UEI) request for a channel state information (CSI) report and (ii) a CSI-related info indicating information about a payload of the CSI report; and
receive the CSI report via a second UL channel in a second slot.

10. The BS of claim 9, wherein:
the transceiver is further configured to transmit a response to the UEI request via a downlink control information (DCI), and
the response includes at least one of a CSI request and an UL resource based on the CSI-related info.

11. The BS of claim 9, wherein:
the CSI-related info includes information about at least one rank indicator (RI) or rank value, and
the at least one RI or rank value indicates the information about the payload of the CSI report.

12. The BS of claim 9, wherein:
the CSI-related info includes an information about a number of non-zero coefficients, and
the number of non-zero coefficients indicates the information about the payload of the CSI report.

13. The BS of claim 9, wherein:
the CSI report is included in uplink control information (UCI),
the UCI is a two-part UCI comprising a UCI part 1 and a UCI part 2,
the UCI part 1 includes a CSI part 1,
the UCI part 2 includes a CSI part 2, and
the CSI part 1 and the CSI part 2 are two parts of the CSI report.

14. The BS of claim 9, wherein the CSI-related info includes information about a pre-configured set of UL resources for the second UL channel from multiple pre-configured sets of UL resources.

15. The BS of claim 9, wherein the first UL channel is a physical uplink control channel (PUCCH).

16. The BS of claim 9, wherein the second UL channel is a physical downlink shared channel (PUSCH).

17. A method performed by a user equipment (UE), the method comprising:
transmitting, via a first uplink (UL) channel in a first slot, (i) a UE initiated (UEI) request for a channel state information (CSI) report and (ii) a CSI-related info indicating information about a payload of the CSI report;
determining the CSI report; and
transmitting the CSI report via a second UL channel in a second slot.

18. The method of claim 17, further comprising:
receiving a response to the UEI request via a downlink control information (DCI),
wherein the response includes at least one of a CSI request and an UL resource based on the CSI-related info.

19. The method of claim 17, wherein:
the CSI-related info includes information about at least one rank indicator (RI) or rank value, and
the at least one RI or rank value indicates the information about the payload of the CSI report.

20. The method of claim 17, wherein:
the CSI-related info includes an information about a number of non-zero coefficients, and
the number of non-zero coefficients indicates the information about the payload of the CSI report.
